(19) United States
(12) Patent Application Publication
(10) Pub. No.: US 2010/0278599 A1
(43) Pub. Date: Nov. 4, 2010

(54) CUTTING INSERT COMPRISING A RIBBED SWARF GUILDING LEVEL

(76) Inventors: Wolfgang Zitzlaff, Kirchheim/Teck (DE); Raouf Ben Amor, Lorch (DE); Tina Mirus, Wurzburg (DE)

Correspondence Address: FULBRIGHT & JAWORSKI, LLP, 666 FIFTH AVE, NEW YORK, NY, 10103-3198, US

(21) Appl. No.: 12/600,848

(22) PCT Filed: May 19, 2008
(86) PCT No.: PCT/EP08/56094

§ 371 Date: Jul. 8, 2010

(30) Foreign Application Priority Data
May 21, 2007 (DE) 10 2007 023 831.4
Oct. 15, 2007 (DE) 10 2007 000 506.9

(51) Int. Cl. B23P 15/28

(52) U.S. Cl. 407/114

(57) ABSTRACT

A cutting insert wherein, in particular an indexable cutting insert for machining predominantly metal materials, comprising a first surface that acts as a contact surface for a chuck tool and a depression in the first surface in the cutting corner region and along the cutting edges, said depression acting as a swarf surface. To reinforce and stabilize the cutting edge, the first swarf surface border or the second swarf surface border has or have one or more interruptions in the form of ribs surface, said ribs lying on the same plane as the second surface.

The invention relates to a cutting plate, in particular an indexable cutting plate, for machining mostly metallic materials having a first surface that serves as a contact face for a chucking tool and a depression that is referred to as a swarf face in the first surface in the cutting corner region and along the cutting edges, wherein a second surface that likewise serves as a contact face is arranged between the cutting edges and the first swarf-face borders of the swarf face facing the cutting edges and between the cutting corner and the second swarf-face border of the swarf face facing the cutting corner.

In the prior art for machining steel and grey cast iron and alloys thereof there is a large range of swarf-forming and swarf-guiding geometries in hard metal and cermet cutting plates, but not in the case of cutting plates made from ceramic material. The use of complex geometries cannot therefore be found in the case of cutting plates made from ceramic material. The previous technical outlay for the production of the cutting ceramic material with complex geometries and also the brittleness of the workpieces made from cast materials (grey cast iron) that are to be processed in most cases have hitherto scarcely allowed this to become possible or required it.

Modern casting materials with high levels of alloying constituents nowadays, however, also require the use of swarf-guiding geometries in cutting plates that are made from ceramic material, mixed ceramic material, cubic boron nitrite or polycrystalline diamonds. An improved swarf runoff and lower demands on the machines for power are called for at the same time. A “softer” and easier cut through positive rake angles can only be realized with the disadvantage of having smaller wedge angles and thus mostly more unstable cutting edges. Workpiece surfaces meeting demands and cutting conditions plus great edge stability of the cutting plates for a long service life for the purposes of economical and process-reliable machining are further requirements of the metal-removing industry.

The underlying object of the invention is reinforcement and stabilization of the cutting edge.

In accordance with the invention this object is achieved in that the first swarf-face border and/or the second swarf-face border have/has one to a multiple of interruptions as a result of webs extending substantially perpendicularly with respect to the cutting edge and/or cutting corner and into the swarf face, with the webs lying in one plane with the second surface. This serves to reinforce and stabilize the cutting edge.

In a development of the invention the webs are formed as peninsulas in a plan view of the swarf face. As a result, the cutting edges are reinforced and stabilized in an optimal way. They are in the form of peninsulas in order to have a contact in the cutting edge region that is as wide as possible and as a result stable. In accordance with the invention the webs taper towards the rear in order to create more space for the swarf runoff.

In a further development of the invention the first and the second surface serving as contact faces lie in one and the same plane and form the surface of the cutting plate. The cutting plate in the chucked or clamped situation as a result not only lies in the centre, but also with its whole border region on a base.

In an alternative development the second surface extends at an angle that is greater or smaller than 0° with respect to the first surface. The contact face of the second surface would then be only a line contact of the cutting edge and no longer a surface contact.

In a development of the invention the first swarf-face border extends at an almost parallel distance with respect to the cutting edges, as a result of which the second surface is of the same size all over.

The webs in a development of the invention constitute the start of one or more continuously sloping reinforcing ribs in the swarf face which in relation to the surface extend concavely, almost perpendicularly with respect to the cutting edges, and run into the deepest region of the swarf face. The cutting plate has, as a result of its special surface geometry, a depression as a swarf face with particular properties for diverting the swarf that accumulates. To be mentioned as a particular feature of this swarf face or swarf-guiding geometry or even swarf-guiding step are the reinforcing ribs that are located in it, starting from webs which run approximately at right angles to the cutting edge and impart an undulating character to the swarf face. This likewise serves to reinforce and stabilize the cutting edge with simultaneous use of a positive rake angle.

Arranged between the webs, starting from the first swarf-face borders, there are preferably swarf runoff faces that extend in a sloping manner as far as the deepest region of the swarf face. As a result, inter alia a positive rake angle is created.

In a development of the invention, the swarf runoff faces are arranged adjacently to the reinforcing ribs.

The deepest region of the swarf face turns into the first surface, in a development of the invention, by way of rising regions.

In a further development, viewed perpendicularly with respect to the cutting edge, the maximum distance of the cutting edge to the point of the web that projects furthest into the swarf face is longer than, up to twice as long as, the distance from the cutting edge to the first swarf-face border. As a result, the cutting edge is sufficiently reinforced.

In a development the webs are arranged singly or multiply and so as to be distributed in a uniform or non-uniform manner along the first and/or second swarf-face border. The spacing of the webs on the swarf-face border can thus be adapted to the requirements.

In order to improve the swarf diversion, the rake angles a of the surfaces of the reinforcing ribs are equal to or greater than the rake angles b of the swarf runoff faces.

In a development of the invention, the swarf face is formed in an undulating manner in the direction of the cutting edges.

In a further development of the invention a protective boundary rib extends concavely in the swarf face on the diagonal from the cutting corner towards the cutting plate centre and in this region forms the upper edge and the start of the undulating swarf face.

In a development of the invention the respective rake angles b of the surfaces of the reinforcing ribs, when reinforcing ribs occur multiply, are identical to each other or different. Different rake angles would result in longer swarf that develops being curved in a non-uniform manner and thus breaking more easily.

In a further development of the invention the respective rake angles a of the swarf runoff faces are identical to each other or different. Different rake angles make swarf compression possible.

In a further development the rake angle a is greater than or equal to the rake angle b. Here it is a question of configuring the originally uniform wave form, in other possible variants, in a non-uniform manner so that the swarf obtains a non-uniform curvature and distortion.

In a development the swarf face in a plan view has a contour like a butterfly, with the body being formed by the boundary rib and the wings being formed by the reinforcing ribs, the swarf runoff faces and the rising regions.

The cutting plate in accordance with the invention preferably consists of a ceramic material or mixed ceramic material, because the geometry that has been described is adapted to these materials.

The cutting plate in accordance with the invention is preferably an indexable cutting plate which when machining in turning, milling and boring processes serves to remove certain material layers on defined workpieces.

Subject matter of this invention is the provision of a special cutting plate for the demands mentioned that is made from ceramic material or mixed ceramic material with particular swarf-guiding geometry. The use of this swarf-guiding geometry in accordance with the invention in other hard materials is of course also conceivable.

In an inventive embodiment the back of the boundary rib, as a variant for particularly intense stress, can also reach up as far as the first and second surface denoted in the figures by 5 and 27, or the contact faces, and with these two surfaces form a continuous plane-parallel and identical face.

The invention is explained in the following with the aid of figures.

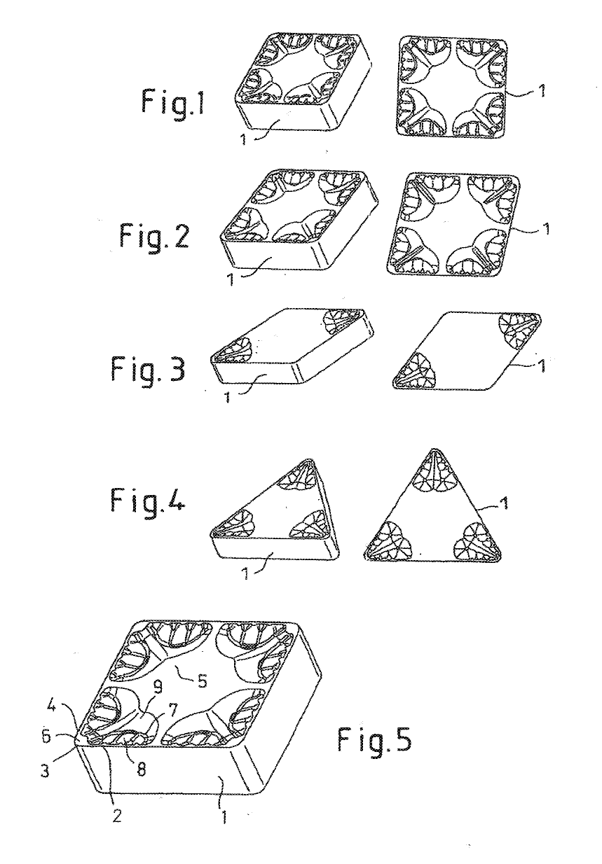

FIGS. 1 to 4 show examples of cutting plates in accordance with the invention with the particular swarf-guiding geometry referred to as the swarf face, represented in various cutting plate forms, as used in the machining industry. All the cutting plates shown are indexable cutting plates 1. FIG. 1 shows an indexable cutting plate 1 with a square basic form which will be described further in detail later. FIGS. 2 and 3 show indexable cutting plates 1 with a basic form in the form of a parallelogram, and FIG. 4 shows an indexable cutting plate 1 with a basic form in the form of a triangle.

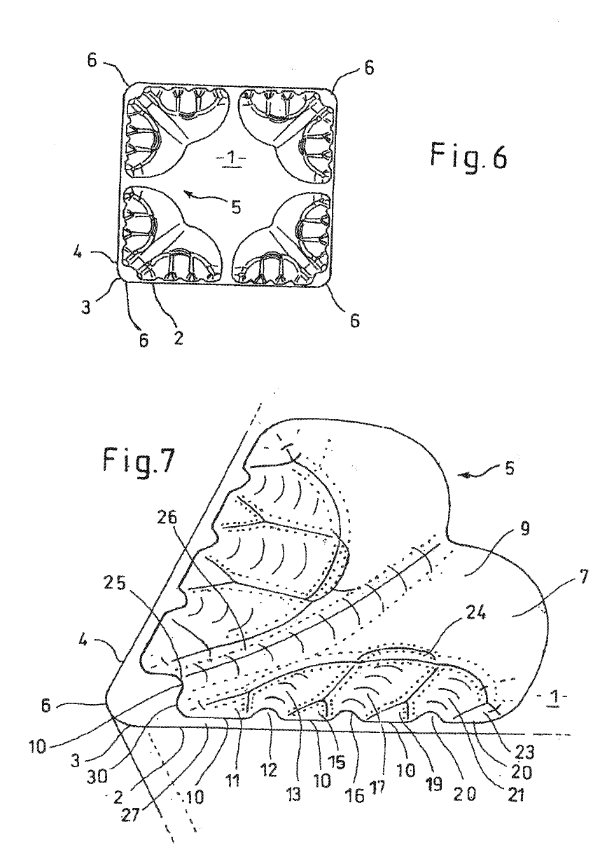

FIG. 5 shows the three-dimensional view of a square indexable cutting plate 1; FIG. 6 shows the plan view of just such a plate.

A cutting plate or indexable cutting plate 1, also called a cutting body or cutting insert in the following, always has at least one cutting edge 2 as a main edge, a corner radius 3 and a cutting edge 4 as a minor edge and also a first surface 5 as a face for chucking in a suitable carrier tool. Depending on the selected cutting-body form, as can be seen in FIG. 6, up to four cutting corners 6 can be present. The indexable cutting plate 1 can be rotated several times during use on a carrier tool in a suitable plate seat after a certain machining time and recognizable signs of wear in order to bring corner edges 6 that are not spent into use again. In the case of some cutting-body types the underside can also be turned upwards, and twice the number of cutting corners 6 are accordingly available. The person skilled in the art also derives the term indexable cutting plate 1 for cutting bodies of this kind therefrom. Embodiments of indexable cutting plates 1 can be constructed, as shown and described here, with a smooth surface or even with troughs or a hole in the cutting-body centre. These features and regions serve to secure the indexable cutting plate 1 in the suitable plate seat on a carrier tool. In this case, the person skilled in the art mostly uses the chucking claws, clamping wedges or screws specifically provided therefor.

The particular features and properties of this invention are explained further in FIG. 7, an enlargement of a cutaway portion of the cutting corner 6 from FIG. 5. An inventive feature of this indexable cutting plate 1 is the depression that is provided in the region of the cutting corner 6 that is referred to as a swarf face and is also referred to as a swarf-guiding step, because it diverts the swarf.

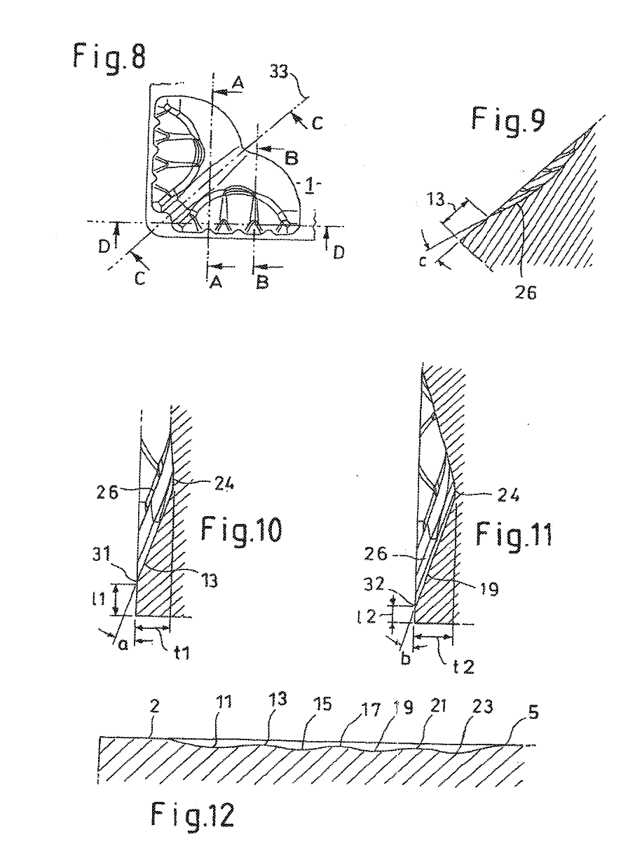

The indexable cutting plate 1 described here has a first surface 5 which serves as a contact face for a chucking tool and a depression which is referred to as a swarf face in the first surface 5 in the cutting corner region and along the cutting edges 2, 4. Arranged between the cutting edges 2, 4 and the first swarf-face borders 10 of the swarf face facing the cutting edges 2, 4 and between the cutting corner 6 and the second swarf-face border 30 of the swarf face facing the cutting corner 6 there is a second surface 27 likewise serving as a contact face. These first swarf-face borders 10 form the border of the swarf face towards the cutting edges 2, 4 and can also be referred to as the start of the swarf-guiding step. These swarf-face borders 10 are arranged at a defined and almost parallel distance 12 (see FIG. 10 in which a section along the line A-A of FIG. 8 is shown) behind the cutting edge 2.

In order to divert the swarf away from the cutting edges 2, 4, swarf runoff faces 11, 15, 19, 23 are arranged in the swarf face, continuing as specially shaped, positively sloping regions as far as the deepest region 24 of the swarf face. There they change direction in order, by way of a further specially shaped and swarf-directing rising region 7 and 9, to end back in the first surface 5 of the indexable cutting plate 1.

The first and second surface denoted by 5 and 27 are here plane-parallel or identical and in this case form the surface 5 of the indexable cutting plate 1 which, viewed in a mirror-inverted manner, in turn forms the contact face on the in turn plane-parallel underside of the indexable cutting plate 1. These contact faces 5 and 27 must be large enough and planar so that the indexable cutting plate 1 has the greatest possible contact in the plate-seat base in the corresponding carrier tools and moreover the best possible cutting-edge support in order to withstand the cutting forces that develop during machining.

The circumferential second surface 27 in the cutting corner region and along the cutting edges 2 and 4 can also extend at an angle that is greater than or smaller than 0° with respect to the surface 5 at the circumference of the indexable cutting plate 1.

The particular feature of this circumferential second surface 27, also called a cutting edge face, is the webs or lands 12, 16 and 20 in the form of peninsulas that issue from it and in each case interrupt the first swarf-face border 10 (start of swarf-guiding step) and partially widen the cutting edge surface 27 along the cutting edge 2 and serve especially to stabilize the cutting edge and increase the planar contact.

These webs 12, 16 and 20 are longer, up to twice as long, in their length 11 (see FIG. 10) than the width 12 (see FIG. 11 which shows a section along the line B-B of FIG. 8) of the cutting edge face 27 along the actual cutting edge 2 and are arranged singly or multiply along the cutting edges 2, 4 in an almost parallel manner. The webs 12, 16, 20 (also called web faces) at the same time also constitute the start of further concavely arched reinforcing ribs 13, 17, 21 that extend between the swarf runoff faces 11, 15, 19, 23, described at the beginning, in the direction of the cutting plate centre.

The webs 12, 16 and 20 and the reinforcing ribs 13, 17, 21 following on therefrom separate the swarf runoff faces 11, 15, 19, 23 at equal or unequal intervals. The width of the webs 12, 16, 20 is mostly at least as wide as the cutting edge face 27 itself and depending on the cutting-edge length and number of webs can turn out differently in terms of form and number.

The main edge width 12 (see FIG. 11) for most cases of use amounts to 0.05 mm to 2 mm and generally additionally has specific cutting edge preparations, such as rounded portions, bevels and double bevels. The selection of the cutting edge preparations plays an important part in machining. They are disregarded here in the further description since they do not pertain to the subject matter of the invention. The spacing, size and number of the webs and reinforcing ribs are adapted, moreover, depending on the type of indexable plate, material, necessary cutting depths and empirical cases of use. The distance of the cutting edge 2, 4 to the first swarf-face border 10 is what is understood by the main edge width 12, viewed perpendicularly to the cutting edge 2, 4 (see reference symbols 12 and 32 in FIG. 11).

These features are shown once again more clearly in FIGS. 8 to 12 in the sectional courses A-A through webs and reinforcing ribs, B-B through the swarf runoff face, C-C through the boundary rib 26, and D-D parallel to the cutting edge 2.

The sloping angle a of the raised region of the swarf face formed by the reinforcing ribs 13, 17, 21 is equal to or greater than the angle b of the lower-lying swarf runoff faces 11, 15, 19, 23 (see FIGS. 10 and 11, each of which shows a section from FIG. 8). The width of the cutting edge 2, that is, the distance 12 (main edge width) between the cutting edge 2 and the first swarf-face borders 10 (denoted by the reference numeral 32 in FIG. 11), for most cases of use amounts to 0.05 mm to 2 mm and generally additionally has specific cutting-edge preparations, such as rounded portions, bevels and double bevels.

The particular configuration of the reinforcing ribs 13, 17, 21, which in accordance with the invention project out of the swarf face in the form of ribs and lead away from the cutting edge 2 to the central and deepest region 24 of the swarf face, give rise in total to an undulating swarf face. This can be seen particularly clearly in FIG. 12 in the section D-D from FIG. 8. The wave crests of this swarf face are formed by the reinforcing ribs 13, 17, 21 and the course thereof, and as a result of their form as ribs render possible a reinforcement between the wave troughs of the lower-lying region of the swarf runoff face 11, 15, 19, 23. As a result, a softer, more positive swarf runoff is rendered possible and a smaller wedge angle is formed with simultaneously high edge stability.

The wave form, which originates at the webs 12, 16, 20, stabilizes the cutting edge 2 and the second surface 27, or the cutting-edge face, is enlarged and reinforced thereby.

A further particular feature is the boundary rib 26 shown in FIG. 9 in the sectional view C-C of FIG. 8 that extends concavely and in an arched form to the cutting-plate centre and is formed so as to be higher than the deepest region 24 of the swarf face. This boundary rib 26 forces the swarf that accumulates during the machining process backwards away from the cutting edge 2 and the corner radius 3 and by means of its elevation, which in turn is ribbed, protects the minor edge 4 from damage by the impact of the swarf that is to be carried away and which develops at the cutting edge 2 of the main edge. This is particularly advantageous when indexable cutting plates 1 that have the particular swarf-guiding step features described here are used in a milling operation. In this case, the planar face of the workpiece is mostly generated by the cutting edge 4 of the minor edge. Here there is an undamaged cutting edge 4 of the minor edge and controlled swarf-diversion for the attainment of a high level of surface quality at the workpiece, and this is of great importance for economical and efficient machining. In an inventive embodiment the back of the boundary rib 26, as a variant for particularly intense stress, can also reach up as far as the first and second surface denoted by 5 and 27, or contact faces, and with these two surfaces form a continuous plane-parallel and identical face.

1-20. (canceled)

21. An indexable cutting plate for machining mostly metallic materials comprising
a first surface that serves as a contact face for a chucking tool; and
a depression that is referred to as a swarf face in the first surface in the cutting corner region and along the cutting edges, wherein a second surface that serves as a contact face is arranged between the cutting edges and the first swarf-face borders of the swarf face facing the cutting edges and between the cutting corner and the second swarf-face border of the swarf face facing the cutting corner, wherein at least one of the first swarf-face border or the second swarf-face border has one to a multiple of interruptions as a result of webs extending substantially perpendicularly with respect to at least one of the cutting edge or cutting corner and into the swarf face, with the webs lying in one plane with the second surface.

22. A cutting plate according to claim 21, wherein the webs are formed as peninsulas in a plan view of the swarf face.

23. A cutting plate according to claim 21, wherein the first and the second surface serving as contact faces lie in one and the same plane and form the surface of the cutting plate.

24. A cutting plate according to claim 21, wherein the surface extends at an angle that is greater or smaller than 0° with respect to the first surface.

25. A cutting plate according to claim 21, wherein the first swarf-face border extends at an almost parallel distance with respect to the cutting edges.

26. A cutting plate according to claim 21, wherein the webs constitute the start of one or more continuously sloping reinforcing ribs in the swarf face which in relation to the first surface extend concavely, almost perpendicularly with respect to the cutting edges, and run into the deepest region of the swarf face.

27. A cutting plate according to claim 21, wherein arranged between the webs, starting from the first swarf-face borders, there are swarf runoff faces that extend in a sloping manner as far as the deepest region of the swarf face.

28. A cutting plate according to claim 27, wherein the swarf runoff faces are arranged adjacently to the reinforcing ribs.

29. A cutting plate according to claim 21, wherein the deepest region of the swarf face turns into the first surface by way of rising regions.

30. A cutting plate according to claim 21, wherein viewed perpendicularly with respect to the cutting edge the maximum distance of the cutting edge to the point of the web that projects furthest into the swarf face is longer than, up to twice as long as, the distance from the cutting edge to the first swarf-face border at a point.

31. A cutting plate according to claim 21, wherein the webs are arranged singly or multiply and so as to be distributed in a uniform or non-uniform manner along at least one of the first or second swarf-face border.

32. A cutting plate according to claim 26, wherein the rake angles a of the surfaces of the reinforcing ribs are equal to or greater than the rake angles b of the swarf runoff faces.

33. A cutting plate according to claim 26, wherein the swarf face is formed in an undulating manner in the direction of the cutting edges.

34. A cutting plate according to claim 21, wherein a protective boundary rib extends concavely in the swarf face on the diagonal from the cutting corner towards the cutting plate centre and in this region forms the upper edge and the start of the undulating swarf face.

35. A cutting plate according to claim 26, wherein the respective rake angles b of the surfaces of the reinforcing ribs, when reinforcing ribs occur multiply, are identical to each other or different.

36. A cutting plate according to claim 32, wherein the respective rake angles a of the swarf runoff faces are identical to each other or different.

37. A cutting plate according to claim 26, wherein the rake angle a is greater than or equal to the rake angle b.

38. A cutting plate according to claim 21, wherein the swarf face in a plan view has a contour like a butterfly, with the body being formed by the boundary rib and the wings being formed by the reinforcing ribs, the swarf runoff faces and the rising regions.

39. A cutting plate according to claim 21, wherein the cutting plate consists of a ceramic material or mixed ceramic material.

40. A cutting plate according to claim 34, wherein the back of the boundary rib reaches up as far as the first and second surface denoted by and, or the contact faces, and with these two surfaces forms a continuous plane-parallel and identical face.
